(19) United States
(12) Patent Application Publication
(10) Pub. No.: US 2013/0089386 A1
(43) Pub. Date: Apr. 11, 2013

(54) Variable-Tooth-Thickness Worm-Type Tool and Method For Using The Same To Fabricate Gears

(71) Applicants: Zhang-Hua FONG, Minxiong Township (TW); Ruei-Hung Hsu, Taichung City (TW); Wei-Hsiang Wang, Tainan City (TW)

(72) Inventors: Zhang-Hua FONG, Minxiong Township (TW); Ruei-Hung Hsu, Taichung City (TW); Wei-Hsiang Wang, Tainan City (TW)

(21) Appl. No.: 13/425,048

(22) Filed: Mar. 20, 2012

(30) Foreign Application Priority Data
Oct. 7, 2011 (TW) 100136599

(51) Int. Cl. B23F 15/00; B23F 21/00

(52) U.S. Cl. 409/48; 407/20

(57) ABSTRACT

A variable-tooth-thickness worm-type tool comprises a main body and a spiral blade distributed on the main body and featuring variable tooth thickness. The main body and the spiral blade are respectively described with a rack cutter coordinate system and a tool coordinate system. The vector parameters based on the rack cutter coordinate system are transformed into vector parameters based on the tool coordinate system so as to simulate the main body with a rack cutter and develop the spiral blade to have variable tooth thickness. Thus, when a gear blank is tooled, the distance between the centers of the tool holder and the workpiece holder can be set as a constant, and the feed in the radial degree-of-freedom can be neglected, with twists of tooth flanks being inhibited.

### BACKGROUND OF THE INVENTION

1. Field of the Invention

The present invention relates to a tool for fabricating gears, particularly to a variable-tooth-thickness worm-type tool for fabricating gears.

2. Description of the Related Art

Refer to FIG. 1 for a conventional worm-type tool, which applies to a generative-type gear fabrication machine to produce various cylindrical gears. Cylindrical gears are indispensable components for automobile industry, machinery industry, electromechanical industry and even aerospace industry. The current industry normally installs a worm-type tool in a generative-type gear fabrication machine to perform precision crowning and tapering processes of cylindrical gears, wherein the lead crowing of cylindrical gears are realized via varying the distance between the centers of the tool and the worked gear. However, such a technology will cause twisted gear flanks unless the crossed angle of the axes of the tool and the worked gear is varied in a very complicated way.

For an example, a U.S. Pat. No. 0,311,063 of the Fette GmbH and Liebherr-Verzahntechnik companies disclosed a technology for varying the pressure angle of the tool. As shown in FIG. 1, the tool machine drives the tool to move along the axis thereof to vary the distance between centers of the tool and the worked gear so as to reduce the tooth flank twist of the worked gear. The prior art has to modify the tilt direction of the pressure angle of the tool along the lead of the tool and thus needs an extra degree-of-freedom for that. Therefore, the prior art has to spend more money on modifying the tool. Further, programming and computation for too modification and gear fabrication is pretty complicated in the prior art.

For another example, a U.S. Pat. No. 5,338,134 disclosed a technology, wherein the precision worm-type tool has different left and right pressure angles, and wherein the tool machine feeds the tool longitudinally and radially to process the gear flanks. However, the conventional technology only uses a single side of the tool to process the tooth flanks, and the other side of the tool does not undertake tooth flank processing. Although the conventional technology can prolong the service of the tool, it has lower fabrication efficiency. Further, it does not solve the problem of twisted gear flanks.

For a further example, a U.S. Pat. No.7,937,182 disclosed a technology, which varies the ratio of diagonals and the distance of centers of the tool and the workpiece to fabricate gears, wherein the amount and path of crowning and the diagonal ratio are coordinated to obtain the required twist of gear profiles. All the abovementioned conventional technologies are realized via varying the pressure angle and the tool feed. Therefore, the conventional technologies have relatively higher costs. However, they do not necessarily reduce the twist of tooth flanks.

It can be commented that the industry normally lead-crowns cylindrical gears via varying the distance between the centers of the tool and the worked gear. However, the conventional technologies would cause twisted tooth flanks unless the crossed angle between the axes of the tool and the worked gear. In fact, the manufacturers normally maintain the crossed angle at a constant lest the rigidity of tool machine be affected. Consequently, the tooth flanks are usually twisted, and the precision of the assembled machine is likely to be affected by that.

### SUMMARY OF THE INVENTION

One objective of the present invention is to provide a variable-tooth-thickness (VTT) worm-type tool, which can solve the problem of twisted tooth flanks, neither needing an extra degree-of-freedom nor increasing the fabrication complexity.

The present invention proposes a variable-tooth-thickness worm-type tool to fabricate a gear blank into a gear. In one embodiment, the VTT worm-type tool comprises a main body and a spiral blade. The spiral blade is distributed on the main body and features variable tooth thickness.

In one embodiment, the tooth thickness is gradually decreased from one end of the main body to the other end. In one embodiment, the tooth thickness is gradually decreased from one end of the main body to the center, and then gradually increased from the center to the other end. In the present invention, the tooth thickness is varied linearly or nonlinearly.

In one embodiment, the VTT worm-type tool cooperates with a generative-type tool machine to fabricate gears. The generative-type tool machine of the present invention comprises a tool holder, a DOF (degree-of-freedom) control mechanism, and a workpiece holder. The main body of the VTT worm-type tool is installed in the tool holder. The DOF control mechanism is used to control the tool holder and has a longitudinal feeding DOF, a tangential feeding DOF, and an inclined angle DOF. The gear blank is installed in the workpiece holder and tooled by the VTT worm-type tool. As the spiral blade has variable tooth thickness in the present invention, the distance between the centers of the tool holder and the workpiece holder remains constant. Thus, the VTT worm-type tool of the present invention can save the tool machine the radial feeding DOF that is used to vary the distance between centers. Further, the VTT worm-type tool of the present invention can crown gears and prevent from twists of tooth flanks.

Another objective of the present invention is to provide a method for using a VTT worm-type tool to fabricate cylindrical gears, which can crown cylindrical gears in high efficiency and low cost.

The present invention also proposes a method for using a VTT worm-type tool to fabricate a gear blank into a cylindrical gear. In one embodiment, the method of the present invention comprises steps: describing a main body of a worm-type tool with a rack cutter coordinate system; describing a spiral blade with a tool coordinate system; converting the vector parameters based on the rack cutter coordinate system into the vector parameters based on the tool coordinate system to simulate the main body of the worm-type tool with a rack cutter and develop the VTT feature of the spiral blade; and neglecting the radial feeding DOF, and setting the feeding amounts in the longitudinal feeding DOF, tangential feeding DOF, and inclined angle DOF according to the VTT feature, for crowning a gear and inhibiting tooth flank twist.

In one embodiment, the rack cutter coordinate system S₇ has three axes x₇, y₇ and z₇ vertical to each other. In the rack cutter coordinate system S₇, the position vector of the main body of the worm-type tool is expressed by

$$\begin{matrix}{r}_{7} = {[ {x}_{7} , {y}_{7} , {z}_{7} , 1 ]}^{T} \\ = {[ {u}_{1} cos {α}_{on} , - {u}_{1} sin {α}_{on} + \frac{{s}_{on} ( {v}_{1} )}{2} , {v}_{1} , 1 ]}^{T} ,\end{matrix}$$

and the normal vector of the main body is expressed by

$$\begin{matrix}{n}_{7} = {[ {n}_{x 7} , {n}_{y 7} , {n}_{z 7} ]}^{T} \\ = {[ sin {α}_{on} , cos {α}_{on} , - {bv}_{1} cos {α}_{on} ]}^{T} ,\end{matrix}$$

wherein u₁ and v₁ are the virtual rack cutter parameters of the rack cutter coordinate system S₇, which are used to simulate the main body with a rack cutter, and wherein αₒₙ is the pressure angle in the normal direction, and wherein rₒ₁ is the pitch radius of the tool. Via coordinate transformation, the main body, which is originally described by the rack cutter coordinate system S₇, is described by the tool coordinate system as follows.

In the tool coordinate system S₃, the position vector of the main body is expressed by

r₃=[x₃(v₁,φ₁), y₃(v₁,φ₁), z₃(v₁, φ₁), 1]^{T}

, and the normal vector of the main body is expressed by

n₃=[nₓ₃(v₁,φ₁), n_{y3}(v₁,φ₁), n_{z3}(v₁, φ₁)]^{T}

, wherein the conversion of parameters is according to the following equations:

$${u}_{1} = \frac{sin {α}_{on} ( {s}_{on} ( {v}_{1} ) - 2 {r}_{o 1} {ϕ}_{1} + 2 {v}_{1} sin {β}_{o 1} )}{2 ( cos {β}_{o 1} - {bv}_{1} {cos}^{2} {α}_{on} sin {β}_{o 1} )}$$

x₃=(rₒ₁+u₁ cos αₒₙ) cos φ₁+[2rₒ₁φ₁−cos βₒ₁(sₒₙ(v₁)−2u₁ sin αₒₙ)−2v₁ sin βₒ₁] sin φ₁/2

y₃=(rₒ₁+u₁ cos αₒₙ) sin φ₁+[cos βₒ₁(sₒₙ(v₁)−2u₁ sin αₒₙ)+2v₁ sin βₒ₁−2rₒ₁φₒ₁] cos φ₁/2

z₃=v₁ cos βₒ₁+u₁ sin αₒₙ sin βₒ₁

nₓ₃=sin αₒₙ cos φ₁+cos αₒₙ(bv₁ sin βₒ₁−cos βₒ₁)sin φ₁

n_{y3}=cos βₒ₁(cos αₒₙ−bv₁ sin βₒ₁)cos φ₁+sin αₐₙ sin φ₁

n_{z3}=−cos αₒₙ(sin βₒ₁+bv₁ cos βₒ₁)

Thus, the radial feed E₀−azₐ² (t) is converted into a constant value, wherein Zₒ(t), Zₛ(t) and Eₒ are respectively the longitudinal feed, tangential feed and center distance of an ordinary tool, and wherein zₛ(t)=czₐ(t).

The present invention, the VTT worm-type tool, such as a hob or a worm-type grinder, lead-crowns gears and modifies tooth profiles, cooperating with a tool machine affording the VTT worm-type tool longitudinal and tangential feeds. In the present invention, it is via varying tooth thickness of the tool to reduce the twist of tooth flanks of the worked gear. The present invention does not need an extra DOF to vary the distance between the centers of the tool and the worked gear but merely needs to enhance the control of the tool machine over the longitudinal movement of the tool. Therefore, the present invention is a low-cost and high-efficiency gear-crowing tool and method.

### BRIEF DESCRIPTION OF THE DRAWINGS

The embodiments are illustrated in detail to make easily understood the objectives, technical contents, characteristics and efficacies of the present invention in cooperation with the drawing briefly described below.

FIG. 1 schematically shows the structure of a conventional worm-type tool;

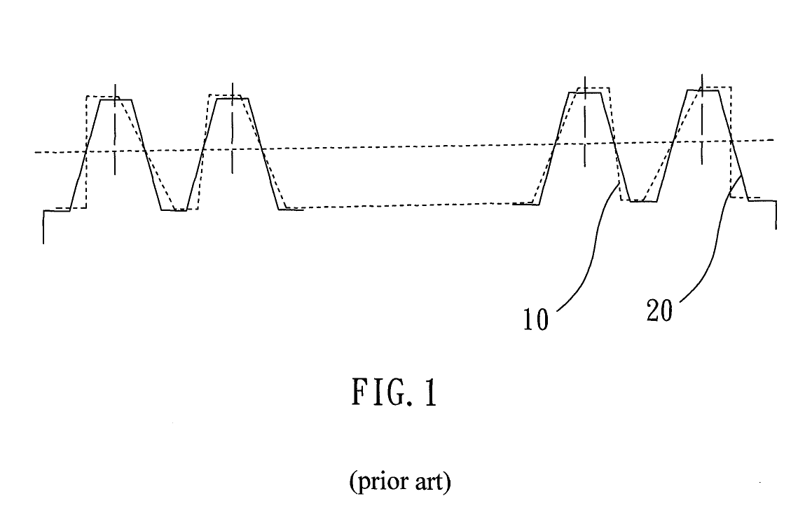

FIG. 2 schematically shows the structure of a VTT worm-type tool according to one embodiment of the present invention;

FIG. 3 schematically shows a generative-type tool machine according to one embodiment of the present invention;

FIG. 4 shows a coordinate system of an ordinary tool used to fabricate a VTT worm-type tool according to one embodiment of the present invention;

FIG. 5 schematically shows the structure of the ordinary tool (shown in FIG. 4) used to fabricate a VTT worm-type tool according to one embodiment of the present invention;

FIG. 6 shows a coordinate system for describing the operation of the ordinary tool (shown in FIG. 4) used to fabricate a VTT worm-type tool according to one embodiment of the present invention;

FIG. 7 showing a coordinate system for describing the case that a VTT worm-type tool processes a gear blank according to one embodiment of the present invention;

FIG. 8 shows the topology of a tooth flank fabricated by a standard tool; and

FIG. 9 shows the topology of a tooth flank fabricated by a VTT worm-type tool according to one embodiment of the present invention.

### DETAILED DESCRIPTION OF THE INVENTION

The present invention proposes a variable-tooth-thickness (VTT) worm-type tool, such as a hob, a blade-type tool or a worm-type grinder. The present invention also proposes a method for using a VTT worm-type tool to fabricate a gear. In the present invention, the VTT worm-type tool cooperates with the longitudinal and tangential feeds of a tool machine to lead-crown gears and modify tooth profile, whereby to reduce tooth flank twists. The present invention needn't vary the distance between the centers of the tool and the worked gear but mainly focuses on controlling the longitudinal movement of the tool machine. The present invention not only exempts the user from complicated DOF setting but also exempts the worked gear from tooth flank twist. Therefore, the present invention can crown cylindrical gears in low cost and high efficiency.

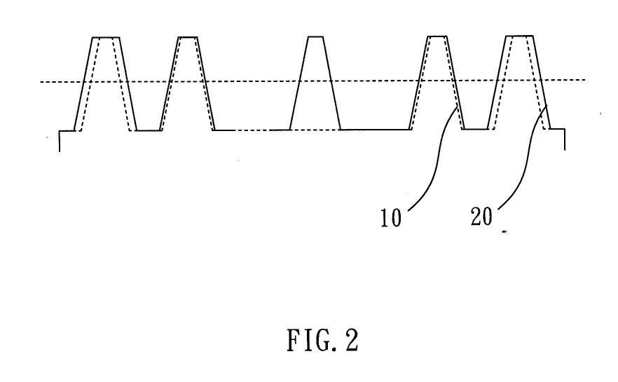

Refer to FIG. 2 showing the structure of a VTT worm-type tool according to one embodiment of the present invention. In the embodiment shown in FIG. 2, distinct from the standard tool 10 drawn with a dotted line, the VTT worm-type tool 20 of the present invention features variable tooth thickness along the spiral blade. In detail, the tooth thickness of the VTT worm-type tool of the present invention is decreased from one end of the tool to the center of the tool, and then increased from the center to the other end.

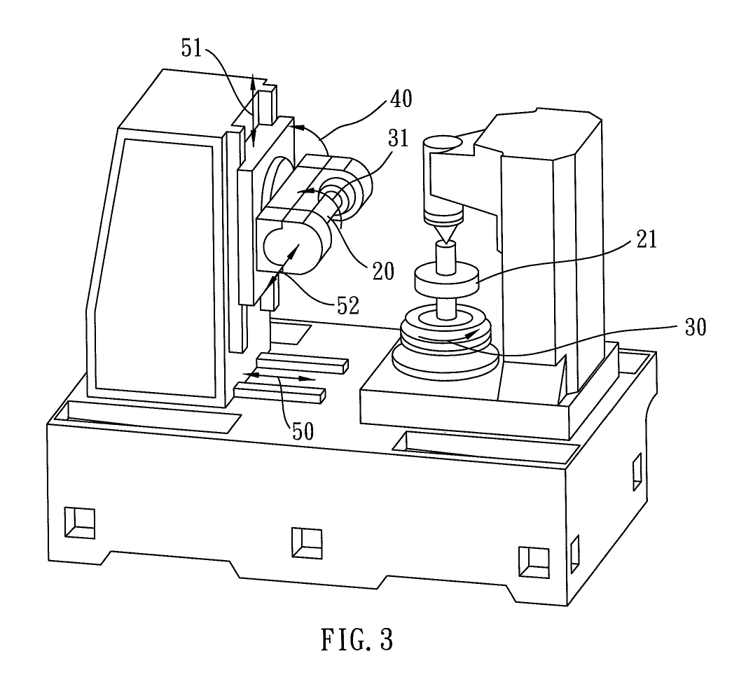

Refer to FIG. 3. In one embodiment, the present invention also proposes a generative-type tool machine cooperating with the abovementioned VTT worm-type tool 20. One side of the generative-type tool machine has a tool holder for installing the VTT worm-type tool 20 and a 3-DOF mechanism for providing the longitudinal feed, the tangential feed and the inclined angle variation. Another side of the generative-type tool machine has a workpiece holder 30 for installing a gear blank 21. When to be tooled by the VTT worm-type tool 20, the gear blank 21 is arranged in the workpiece holder 30 and rotated by the workpiece holder 30 to make the worked region face the tool holder. In details, the tool holder is rotated to the inclined angle 40 set for the VTT worm-type tool 20 and the gear blank 21, and moved to make the VTT worm-type tool 20 and the gear blank 21 have a center distance 50, whereby the VTT worm-type tool 20 contacts a region of the gear blank 21, which is to be cut or to be machined in another way. Once the tooling is started, the VTT worm-type tool 20 is moved along the longitudinal feeding direction 51. At the same time, the VTT worm-type tool 20 is moved along the tangential feeding direction 52 from one end thereof to the other end.

Below is explained in detail why the VTT worm-type tool and the matching generative-type tool machine of the present invention can simplify DOF setting and avoid tooth flank twists simultaneously. Firstly is described the processes of designing and producing the VTT worm-type tool 20.

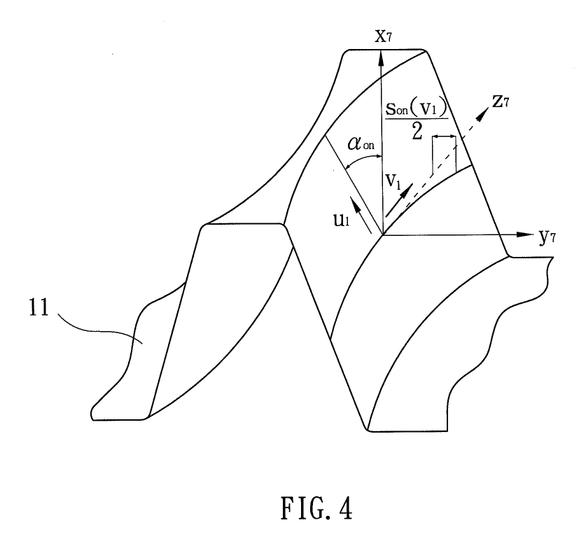

Refer to FIG. 4 showing a coordinate system of an ordinary tool used to fabricate a VTT worm-type tool according to one embodiment of the present invention, wherein the normal vector parameters are used to describe the coordinate system of the ordinary tool. In the embodiment, it is supposed that the theoretical tooth profile of the VTT worm-type tool 20 of the present invention is created by a rack cutter 11. The tooth thickness of the rack cutter 11 along the lead direction is described by a quadratic equation:

sₒₙ(v₁)=bv₁² (1)

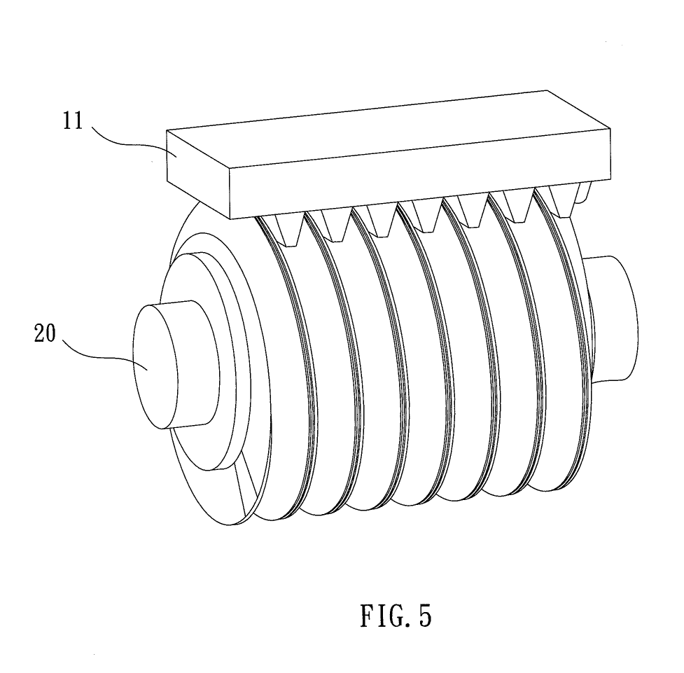

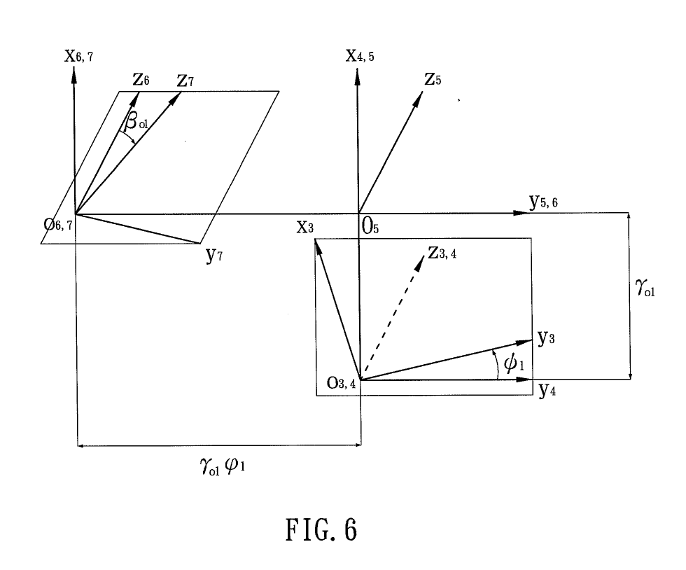

Refer to FIG. 5 and FIG. 6. FIG. 5 schematically shows the structure of the ordinary tool (shown in FIG. 4) used to fabricate a VTT worm-type tool according to one embodiment of the present invention. FIG. 6 shows a coordinate system for describing the operation of the ordinary tool (shown in FIG. 4) used to fabricate a VTT worm-type tool according to one embodiment of the present invention. In FIG. 6, S, is the rack cutter coordinate system whose original point is denoted by O₇; S₃ is the tool coordinate system whose original point is denoted by O₃; S₄ is a fixed coordinate system whose original point is denoted by O₄; the original points of the tool coordinate system S₃ and the fixed coordinate system S₄ coincide. When the rack cutter 11 is moved for a distance of rₒ₁φ₁, the tool is rotated by an angle of φ₁ with respect to the Z axis Z₄ of the fixed coordinate system S₄. Thus, the position vector and normal vector of the tool are respectively expressed by Equation (2) and Equation (3).

Described by the rack cutter coordinate system S₇, the position vector of the tool is expressed as

$$\begin{matrix}{r}_{7} = {[ {x}_{7} , {y}_{7} , {z}_{7} , 1 ]}^{T} \\ = {[ {u}_{1} cos {α}_{on} , - {u}_{1} sin {α}_{on} + \frac{{s}_{on} ( {v}_{1} )}{2} , {v}_{1} , 1 ]}^{T}\end{matrix} \qquad ( 2 )$$

Described by the rack cutter coordinate system S₇, the normal vector of the tool is expressed as

$$\begin{matrix}{n}_{7} = {[ {n}_{x 7} , {n}_{y 7} , {n}_{z 7} ]}^{T} \\ = {[ sin {α}_{on} , cos {α}_{on} , - {bv}_{1} cos {α}_{on} ]}^{T}\end{matrix} \qquad ( 3 )$$

The rack cutter parameters are respectively denoted by u₁ and v₁; αₒₙ is the pressure angle in the normal direction; rₒ₁ is the pitch radius of the tool.

Via coordinate transformation, the position vector and normal vector of the VTT worm-type tool 20 are respectively described by the tool coordinate system as follows.

Described by the tool coordinate system S₃, the position vector of the VTT worm-type tool 20 is expressed as

r₃=[x₃(v₁, φ′₁), y₃(v₁, φ₁), z₃(v₁, φ₁), 1]^{T} (4)

Described by the tool coordinate system S₃, the normal vector of the VTT worm-type tool 20 is expressed as

n₃=[nₓ₃(v₁, φ₁), n_{y3}(v₁, φ₁), n_{z3}(v₁ , φ₁)]^{T} (5)

The conversion of parameters is according to the following equations:

$${u}_{1} = \frac{sin {α}_{on} ( {s}_{on} ( {v}_{1} ) - 2 {r}_{o 1} {ϕ}_{1} + 2 {v}_{1} sin {β}_{o 1} )}{2 ( cos {β}_{o 1} - {bv}_{1} {cos}^{2} {α}_{on} sin {β}_{o 1} )} \\ {x}_{3} = ( {r}_{o 1} + {u}_{1} cos {α}_{on} ) cos {ϕ}_{1} + [ 2 {r}_{o 1} {ϕ}_{1} - cos {β}_{o 1} ( {s}_{on} ( {v}_{1} ) - 2 {u}_{1} sin {α}_{on} ) - 2 {v}_{1} sin {β}_{o 1} ] sin {ϕ}_{1} / 2 \\ {y}_{3} = ( {r}_{o 1} + {u}_{1} cos {α}_{on} ) sin {ϕ}_{1} + [ cos {β}_{o 1} ( {s}_{on} ( {v}_{1} ) - 2 {u}_{1} sin {α}_{on} ) + 2 {v}_{1} sin {β}_{o 1} - 2 {r}_{o 1} {ϕ}_{1} ] cos {ϕ}_{1} / 2 \\ {z}_{3} = {v}_{1} cos {β}_{o 1} + {u}_{1} sin {α}_{on} sin {β}_{o 1} \\ {n}_{x 3} = sin {α}_{on} cos {ϕ}_{1} + cos {α}_{on} ( {bv}_{1} sin {β}_{o 1} - cos {β}_{o 1} ) sin {ϕ}_{1} \\ {n}_{y 3} = cos {β}_{o 1} ( cos {α}_{on} - {bv}_{1} sin {β}_{o 1} ) cos {ϕ}_{1} + sin {α}_{on} sin {ϕ}_{1} \\ {n}_{z 3} = - cos {α}_{on} ( sin {β}_{o 1} + {bv}_{1} cos {β}_{o 1} ) \qquad ( 6 )$$

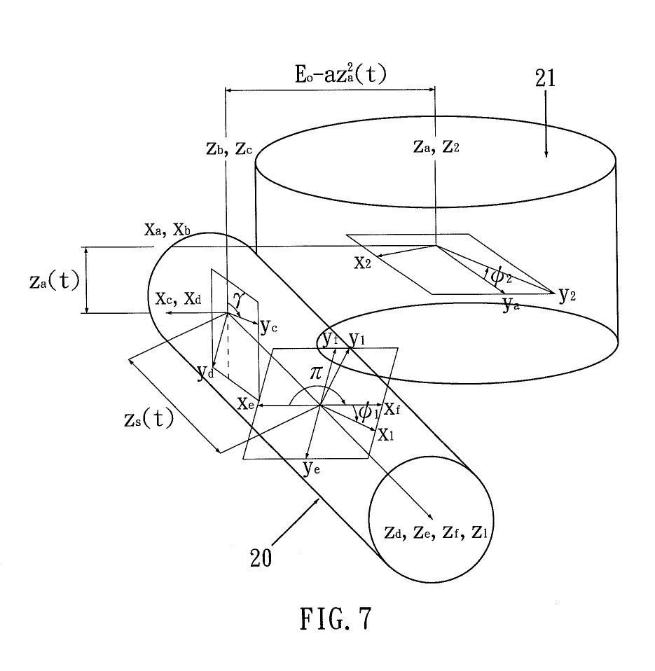

Refer to FIG. 7 showing a coordinate system for describing the case that the VTT worm-type tool 20 is fed diagonally to machine the gear blank 21 (i.e. the workpiece) according to one embodiment of the present invention. In FIG. 7, S₁ is the tool coordinate system (the coordinate system of the x₁ axis and the y₁ axis); S₂ is the workpiece coordinate system; Sₐ is the fixed coordinate system of the tool machine. The tool machine needs to provide three-DOF feeds for an ordinary tool, i.e. the longitudinal feed Zₐ (t) along the axis of the workpiece, the tangential feed Zₛ (t)along the axis of the ordinary tool, and the distance Eₒ between the centers of the ordinary tool and the workpiece. The inclined angle set for the ordinary tool and the workpiece is denoted by γ. When the worked gear is modified along the lead direction by a conventional hobbing process, the hobbing machine has to feed the tool along the longitudinal feeding direction 51 shown in FIG. 3, and the center distance 50 is set for radial feed. The radial feed amount is determined according to Equation (7):

Eₒ−azₐ²(t) (7)

However, the conventional technology is likely to cause tooth flank twists.

The measures that the VTT worm-type tool and the matching tool machine of the present invention overcomes the problem of twisted tooth flanks include setting the center distance 50 to be a constant; providing a tool having variable tooth thickness; and controlling the feeds in the longitudinal feeding direction 51 and the tangential feeding direction 52 according to Equation (8):

zₛ(t)=czₐ(t) (8)

Thus, the profile of the teeth can be obtained via combining the gear theorem, the geometric theorem and Equations (1)-(8) to realize a VTT worm-type tool 20 featuring variable tooth thickness.

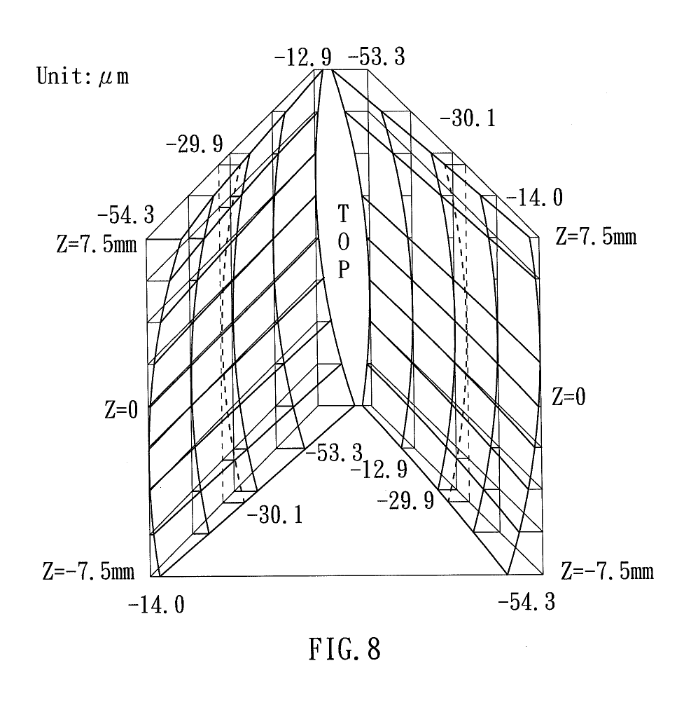

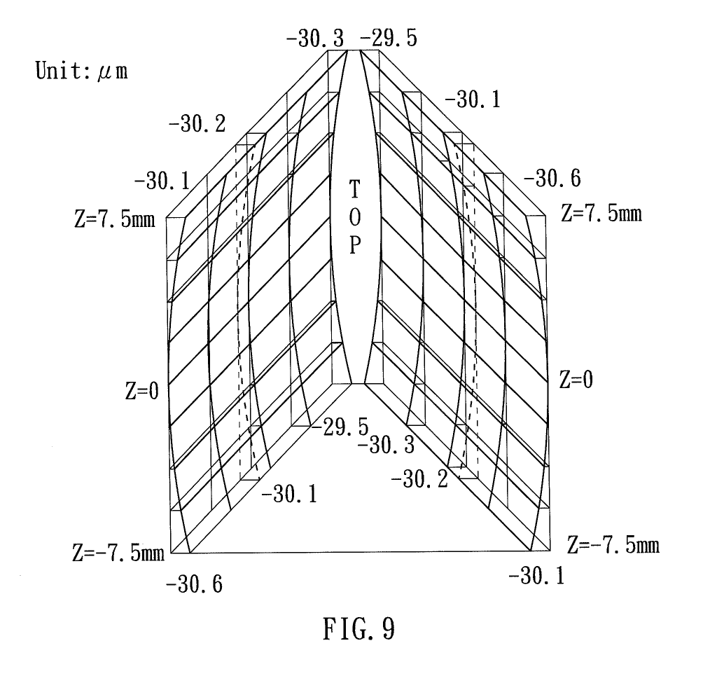

Refer to FIG. 8 and FIG. 9. FIG. 8 shows the topology of a tooth flank fabricated by a standard tool. FIG. 9 shows the topology of a tooth flank fabricated by the VTT worm-type tool of the present invention. Below are provided the examples of the gears respectively fabricated with a conventional standard tool and the VTT worm-type tool of the present invention.

The data of the worked gear includes
Number of teeth=50
Normal module=3 mm
Normal circular-teeth thickness=4.712 mm
Normal pressure angle=20 degrees RH
Helix angle=20 degrees
Face width=15 mm

The data of the tool includes
Number of teeth=1
Helix angle=87.888 degrees RH
Normal circular-teeth thickness=4.712 mm

The operating data of the tool machine includes
Inclined angle of the tool holder=17.888 degrees
Standard distance between the centers of the tool and the gear blank=120.510 mm

When the gear is fabricated with a standard tool, the tool machine feeds the standard tool in the longitudinal feeding direction and the radial feeding direction according to the feeding parameters: a=1.34×10⁻³, b=0, and c=0, wherein a is the center distance variation coefficient, b the tooth thickness variation coefficient, and c the tangential feeding coefficient. As shown in FIG. 8, twists appear in the left and right tooth flanks. When the gear is fabricated with the VTT worm-type tool of the present invention, the tool machine feeds the VTT worm-type tool in the longitudinal feeding direction and the tangentially feeding direction according to the feeding parameters: a=0, b=1.46×10⁻⁷ , and c=−3.256. As shown in FIG. 9, the VTT worm-type tool of the present invention can effectively inhibit the twists of the tooth flanks. Therefore, the present invention can achieve the objective of the lead modification.

The present invention at least has the following advantages:
1. The combination of the VTT worm-type tool and the matching tool machine of the present invention can achieve the target of gear crowning, merely using the longitudinal feed and the tangential feed.
2. The present invention can inhibit tooth flank twist via merely varying the tooth thickness.
3. It is unnecessary for the tool machine fabricating or using the VTT worm-type tool to have an extra DOF or vary the mechanism thereof
4. The tool machine using the VTT worm-type tool needn't vary the distance between the centers of the tool and the worked gear but only needs to feed the tool in the longitudinal direction and the tangential direction.

In conclusion, the VTT worm-type tool and the matching tool machine of the present invention can crown gears and inhibit tooth flank twists in low cost and high efficiency, merely using the longitudinal feed and the tangential feed. Therefore, the present invention implies enormous economic profit and has great industrial utility.

The present invention has been demonstrated in detail with the embodiments. However, the embodiments described abovementioned are only to exemplify the present invention but not to limit the scope of the present invention. According to the specification stated above, any person skilled in the art can easily make various modifications or variations of the present invention without departing from the spirit and scope of the present invention. Therefore, any modification or variation made according to the present invention is to be also included within the scope of the present invention.

What is claimed is:

1. A variable-tooth-thickness worm-type tool, used to fabricate a gear blank into a gear, said variable-tooth-thickness worm-type tool comprising:
a main body; and
at least one spiral blade distributed on said main body and featuring variable tooth thickness.

2. The variable-tooth-thickness worm-type tool according to claim 1, wherein tooth thickness of said spiral blade is gradually decreased from one end of said spiral blade to another end of said spiral blade.

3. The variable-tooth-thickness worm-type tool according to claim 1, wherein tooth thickness of said spiral blade is gradually decreased from one end of said spiral blade to a center of said spiral blade, and then gradually increased from said center of said spiral blade to another end of said spiral blade.

4. The variable-tooth-thickness worm-type tool according to claim 1, wherein tooth thickness of said spiral blade is varied non-proportionally.

5. The variable-tooth-thickness worm-type tool according to claim 1, further comprising:
a tool holder for installing a variable-tooth-thickness worm-type tool;
a degree-of-freedom control mechanism controlling said tool holder to have a longitudinal feeding degree-of-freedom, a tangential feeding degree-of-freedom, and an inclined angle degree-of-freedom; and
a workpiece holder for installing a gear blank,
wherein said spiral blade has variable tooth thickness, and wherein a distance between centers of said tool holder and said workpiece holder is constant to omit a radial feeding degree-of-freedom for varying said distance between said tool holder and said gear blank and to crown said gear blank and inhibit twists of tooth flanks of said gear blank.

6. A method for fabricating a gear blank into a gear with a variable-tooth-thickness worm-type tool according to claim 1, comprising steps:
describing said main body with a rack cutter coordinate system;
describing said spiral blade distributed on said main body with a tool coordinate system;
transforming vector parameters based on said rack cutter coordinate system into vector parameters based on said tool coordinate system so as to simulate said main body with a rack cutter, and developing said spiral blade to have variable tooth thickness; and
according to a structural characteristic of variable-thickness teeth of said spiral blade, setting feeding amounts of a longitudinal feeding degree-of-freedom, a tangential feeding degree-of-freedom, and an inclined angle degree-of-freedom and neglecting a radial feeding degree-of-freedom for crowning said gear blank and inhibiting twists of tooth flanks of said gear blank.

7. The method for fabricating a gear blank into a gear with a variable-tooth-thickness worm-type tool according to claim 6, wherein said rack cutter coordinate system S₇ has three axes x₇ , y₇ and z₇ vertical to each other, and wherein based on said rack cutter coordinate system S₇ a position vector of said main body is expressed by
$$\begin{matrix}{r}_{7} = {[ {x}_{7} , {y}_{7} , {z}_{7} , 1 ]}^{T} \\ = {[ {u}_{1} cos {α}_{on} , - {u}_{1} sin {α}_{on} + \frac{{s}_{on} ( {v}_{1} )}{2} , {v}_{1} , 1 ]}^{T}\end{matrix}$$
, and wherein based on said rack cutter coordinate system S₇, a normal vector of said main body is expressed by
$$\begin{matrix}{n}_{7} = {[ {n}_{x 7} , {n}_{y 7} , {n}_{z 7} ]}^{T} \\ = {[ sin {α}_{on} , cos {α}_{on} , - {bv}_{1} cos {α}_{on} ]}^{T}\end{matrix}$$
, and wherein u₁ and v₁ are virtual rack cutter parameters of said rack cutter coordinate system S₇, which are used to simulate said main body with a rack cutter, and wherein αₒₙ is a normal direction pressure angle, and wherein r₀₁ is a pitch radius.

8. The method for fabricating a gear blank into a gear with a variable-tooth-thickness worm-type tool according to claim 7, wherein said tool coordinate system S₃ has three axes x₃, y₃ and z₃ vertical to each other, and wherein said rack cutter coordinate system S₇ is transformed into said tool coordinate system S₃, and wherein based on said tool coordinate system S₃ said position vector of said main body is expressed by
r₃=[x₃(v₁, φ₁), y₃(v₁, φ₁), z₃(v₁, φ₁), 1]^{T}
, and wherein based on said tool coordinate system S₃, said normal vector of said main body is expressed by
n₃=[nₓ₃(v₁, φ₁), n_{y3}(v₁, φ₁), n_{z3}(v₁, φ₁)]^{T}
, and wherein related parameters are converted according to following equations:
$${u}_{1} = \frac{sin {α}_{on} ( {s}_{on} ( {v}_{1} ) - 2 {r}_{o 1} {ϕ}_{1} + 2 {v}_{1} sin {β}_{o 1} )}{2 ( cos {β}_{o 1} - {bv}_{1} {cos}^{2} {α}_{on} sin {β}_{o 1} )}$$
$${x}_{3} = ( {r}_{o 1} + {u}_{1} cos {α}_{on} ) cos {ϕ}_{1} + [ 2 {r}_{o 1} {ϕ}_{1} - cos {β}_{o 1} ( {s}_{on} ( {v}_{1} ) - 2 {u}_{1} sin {α}_{on} ) - 2 {v}_{1} sin {β}_{o 1} ] sin {ϕ}_{1} / 2$$
$${y}_{3} = ( {r}_{o 1} + {u}_{1} cos {α}_{on} ) sin {ϕ}_{1} + [ cos {β}_{o 1} ( {s}_{on} ( {v}_{1} ) - 2 {u}_{1} sin {α}_{on} ) + 2 {v}_{1} sin {β}_{o 1} - 2 {r}_{o 1} {ϕ}_{1} ] cos {ϕ}_{1} / 2$$
$${z}_{3} = {v}_{1} cos {β}_{o 1} + {u}_{1} sin {α}_{on} sin {β}_{o 1}$$
$${n}_{x 3} = sin {α}_{on} cos {ϕ}_{1} + cos {α}_{on} ( {bv}_{1} sin {β}_{o 1} - cos {β}_{o 1} ) sin {ϕ}_{1}$$
$${n}_{y 3} = cos {β}_{o 1} ( cos {α}_{on} - {bv}_{1} sin {β}_{o 1} ) cos {ϕ}_{1} + sin {α}_{on} sin {ϕ}_{1}$$
$${n}_{z 3} = - cos {α}_{on} ( sin {β}_{o 1} + {bv}_{1} cos {β}_{o 1} )$$

9. The method for fabricating a gear blank into a gear with a variable-tooth-thickness worm-type tool according to claim 8, wherein a radial feed E₀−az ₐ²(t) is converted into a constant value, wherein Zₐ(t), Zₛ(t) and Eₒ are respectively a longitudinal feed, a tangential feed and a distance of centers, and wherein zₛ(t)=czₐ(t).
